(19) United States
(12) Patent Application Publication
(10) Pub. No.: US 2005/0029166 A1
(43) Pub. Date: Feb. 10, 2005

(54) Sifting arrangement for sifting a product stream within a distributor apparatus

(75) Inventors: Peter Schumacher, Elmshorn (DE); Manuel Hansch, Hamburg (DE); Bernhard Jurgens, Wentorf (DE); Rolf Lindemann, Glinde (DE); Reinhard Stuber, Reinbek (DE)

Correspondence Address: GREENBLUM & BERNSTEIN, P.L.C., 1950 ROLAND CLARKE PLACE, RESTON, VA, 20191, US

(73) Assignee: Hauni Maschinenbau AG, Hamburg (DE)

(21) Appl. No.: 10/869,834

(22) Filed: Jun. 18, 2004

(30) Foreign Application Priority Data
Jun. 19, 2003 (EP) 03090184.7

(51) Int. Cl. B07B 1/04

(52) U.S. Cl. 209/356

(57) ABSTRACT

Sifting arrangement for sifting a product stream. The sifting arrangement includes a zigzag sifter having at least one access opening and a sifting chamber that is divided into at least two compartments. The zigzag sifter is substantially vertically oriented. This Abstract is not intended to define the invention disclosed in the specification, nor intended to limit the scope of the invention in any way.

### CROSS-REFERENCE TO RELATED APPLICATIONS

The present application claims priority under 35 U.S.C. § 119 of European Patent Application No. 03090184.7, filed on Jun. 19, 2003, the disclosure of which is expressly incorporated by reference herein in its entirety.

### BACKGROUND OF THE INVENTION

1. Field of the Invention

The invention is concerned with a sifting arrangement for sifting a product stream within a distributor apparatus for loading a cigarette-making machine. The sifting arrangement is constructed as a substantially vertically oriented zigzag sifter and has a sifting chamber forming a sifting zone with at least one access for the product stream to be sifted within the sifting zone.

The product stream is delivered to the sifting arrangement within the distributor device from a reservoir by way of a conveying element, preferably a steep-angle conveyor. The sifted product stream is then conducted on via a transport zone into an accumulating shaft. The sifting arrangement is accordingly mounted in front of the accumulating shaft in the direction of transport of the product stream within the distributor device.

2. Discussion of Background Information

Known sifting arrangements of this kind have a sifting chamber in which fractions of the product stream to be processed are separated from fractions not to be processed by way of an air flow. The product stream is formed from individual tobacco portions which are delivered to the sifting arrangement in the region of an access. Due to the air flow within the sifting arrangement, that is, in the sifting zone defined by the sifting chamber, the tobacco portions are pulled apart uncontrolled, leading to uneven distribution of the product stream across the width of the sifting chamber or sifting zone. As delivery of the product stream to the accumulating shaft is uneven across the width, filling of the accumulating shaft itself is uneven across the width too. Such uneven filling can in turn lead to a fault in the formation of a continuous tobacco strand in the subsequent cigarette-making machine.

### SUMMARY OF THE INVENTION

The present invention provides for a sifting arrangement which allows even filling of the accumulating shaft using a simple system, particularly when the sifting arrangement is mounted in front of the accumulating shaft in the direction of transport of the product stream.

The sifting arrangement includes a sifting chamber that is divided. Due to division of the sifting chamber, even distribution of the product stream or of the tobacco portions across the width of the sifting arrangement or sifting chamber is substantially simplified. This arrangement allows the air flow within the sifting chamber to pull the product stream or tobacco portions apart only to a limited extent. As a result, the accumulating shaft can be filled evenly. Additional mechanisms for making the product stream uniform across the width can therefore be dispensed with.

In a preferred embodiment of the invention, the sifting chamber has several, preferably seven, compartments which are arranged separate from each other. The formation of several individual, independent compartments facilitates even distribution of the product stream across the width of the sifting chamber, so that filling of the subsequent accumulating shaft automatically takes place evenly too.

Advantageously, each compartment has its own access area and/or opening in the region of a front side of the sifting arrangement. This ensures even filling of the sifting chamber, so that the compartments can be filled evenly.

In a further, particularly preferred embodiment of the invention, the compartments are formed by partitions which extend from opposite sides of the sifting arrangement, namely, from the front wall to the rear wall, and particularly advantageously are at least partly apertured and/or opened. This type of construction ensures, in a particularly reliable and at the same time material-saving manner, separation of the product stream into several partial streams within the sifting chamber. Also, the open construction of the partitions allows intervention in the sifting chamber from the outside with little effort, and indeed in all the compartments.

Preferably, the sifting chamber is designed so that it can be inspected from the outside, which ensures constant monitoring of the sifting process on-line.

The invention also provides for a sifting arrangement for sifting a product stream, wherein the sifting arrangement comprises a zigzag sifter comprising at least one access opening and a sifting chamber that is divided into at least two compartments, wherein the zigzag sifter is substantially vertically oriented.

The sifting arrangement may be arranged within a distributor apparatus for loading a cigarette-making machine. The at least one access opening may comprise at least two access openings, each of the at least two access openings allowing entry of the product stream into each of the at least two compartments. The at least two compartments may be at least partially separated from each other. The at least two compartments may be separated from each other by a wall. The at least two compartments may be completely separated from each other. The sifting chamber may be divided into at least three compartments.

The zigzag sifter may further comprise a lower bottom region and an upper outlet region.

The zigzag sifter may comprise a front wall and a rear wall, and wherein the at least one access opening is arranged in a region of the front wall. The at least two compartments may be defined by a partition which extends from opposite sides of the sifting arrangement. The at least two compartments may be defined by a partition which extends from front and rear walls of the zigzag sifter.

The at least two compartments may comprise at least three compartments which are defined by partitions which extend from opposite walls of the zigzag sifter. Free ends of oppositely arranged partitions may be spaced apart from each other so as to define partially open compartments. The partitions may connect to each of the opposite walls so as to define closed compartments. The partitions may extend to an outlet region of the zigzag sifter. The outlet region may be arranged adjacent to a transport zone and downstream of the sifting arrangement, whereby the product stream can be transported from the zigzag sifter via the outlet region to the transport zone. The at least one access opening may comprise at least three access openings, each of the at least three access openings allowing entry of the product stream into each of the at least three compartments. The partitions may extend at least to the at least three access openings.

The at least one access opening may be arranged in a region of at least one of a conveyor and a separating roller. The sifting chamber may be structured and arranged to allow viewing or inspection of its contents from outside. The sifting chamber may comprise side walls which are at least partially transparent. The sifting chamber may comprise front and rear walls which are at least partially transparent. The sifting chamber may comprise a front wall, a rear wall, and oppositely arranged connecting side walls.

The invention also provides for a zigzag sifting arrangement for sifting a product stream, wherein the sifting arrangement comprises a sifting chamber comprising oppositely arranged front and rear walls, oppositely arranged side walls, a plurality of access openings, and a plurality of partition plates extending inwardly from the front and rear walls. The partition plates are at least one of oriented generally parallel to the oppositely arranged side walls, and oriented generally perpendicular to the front and rear walls, wherein the partition plates form a plurality of compartments within the sifting chamber, and wherein each of the plurality of access openings communicates with each of the plurality of at least partially open compartments.

The zigzag sifting arrangement may be substantially vertically oriented. The plurality of compartments may have substantially equal widths. The plurality of compartments may have substantially equal sizes. At least one of the partition plates may extend continuously from a lower bottom region to an upper outlet region of the sifting chamber. Each of the partition plates may extend continuously from a lower bottom region to an upper outlet region of the sifting chamber. The plurality of compartments may comprise partially open compartments. The plurality of compartments may comprise closed compartments.

The invention also provides for a sifting arrangement for sifting a product stream, wherein the sifting arrangement comprises a generally vertically oriented zigzag-shaped sifting chamber comprising oppositely arranged front and rear walls, oppositely arranged side walls, and a plurality of partition plates extending inwardly from the front and rear walls. At least some of the partition plates are connected to at least the front wall. At least some of the partition plates are connected to at least the rear wall. The partition plates are at least one of oriented generally parallel to the oppositely arranged side walls, and oriented generally perpendicular to the front and rear walls. The partition plates form one of a plurality of at least partially open compartments arranged within the zigzag-shaped sifting chamber, and a plurality of closed compartments arranged within the zigzag-shaped sifting chamber.

The partition plates may comprise curved free ends so as to form the plurality of at least partially open compartments arranged within the zigzag-shaped sifting chamber. The partition plates may be connected to the front wall are arranged opposite from the partition plates connected to the rear wall, whereby open areas are defined between the oppositely arranged partition plates, such that the open areas allow movement of the product stream between adjacent compartments. The partition plates may extend between corner regions of the front and rear walls and over the corner regions. The partition plates may extend between adjacent corner regions of the front and rear walls, but not over the corner regions. Each of the partition plates may be connected to each of the front and rear walls so as to form the plurality of closed compartments arranged within the zigzag-shaped sifting chamber. The sifting arrangement may further comprise a plurality of access openings arranged in the front wall for supplying product to the zigzag-shaped sifting chamber.

### BRIEF DESCRIPTION OF THE DRAWINGS

The present invention is further described in the detailed description which follows, in reference to the noted plurality of drawings by way of non-limiting exemplary embodiments of the present invention, in which like reference numerals represent similar parts throughout the several views of the drawings, and wherein:

FIG. 1 shows a side view of a distributor device in section;

FIG. 2 shows a front view of part of the distributor device of FIG. 1, with a sifting arrangement having closed partitions, FIG. 3 shows a top view of the sifting arrangement similar to the one shown in FIG. 2 taken along section III-III, but utilizing open partitions instead of the closed partitions shown in FIG. 2;

FIG. 4 shows a side sectional view of the sifting arrangement of FIG. 3;

FIG. 5 shows a side sectional view of another sifting arrangement;

FIG. 6 shows a perspective view of an open sifting arrangement of the type shown in FIG. 4. The figure shows an internal view of the front wall; and

FIG. 7 shows a perspective view of the steep-angle conveyor used in the distributor device shown in FIG. 1.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

Sifting arrangements are used within distributor devices to sift a product stream, in particular to separate fractions of the product stream to be processed and not to be processed.

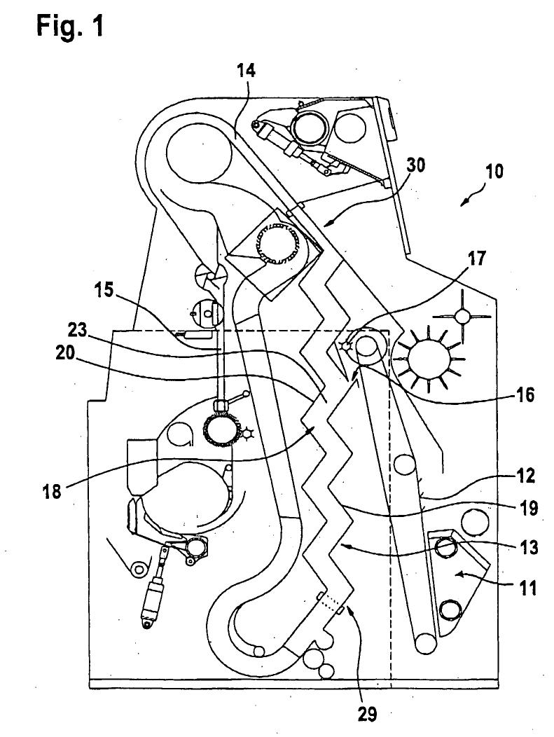

FIG. 1 shows a distributor device 10 and illustrates the essential components which are helpful for an understanding of the invention. These include, in the direction of transport of the product stream and starting from a reservoir 11, a conveyor 12, a sifting arrangement, a transport zone and an accumulating shaft 15. The conveyor 12 is preferably constructed as a steep-angle conveyor. The transport zone 14 adjoins the sifting arrangement 13 and the accumulating shaft 15. The sifting arrangement 13 preferably includes an access region and/or opening area 16 for supplying the tobacco portions delivered by the steep-angle conveyor 12. These tobacco portions form the product stream to be sifted. In the region of the access 16, there is optionally arranged a separating roller 17 which assists the transfer of the tobacco portions from the steep-angle conveyor 12 to the sifting arrangement 13.

The sifting arrangement 13 includes a sifting chamber 18. The sifting chamber 18 is composed of a front wall 19, a rear wall 20 and side walls 21, 22. Within the sifting chamber 18 is defined a sifting zone 23 along which the product stream is sifted by way of an air flow. The front wall 19 and the rear wall 20 are spaced apart from each other and appropriately arranged essentially parallel to each other. As can be seen in FIG. 1, the sifting chamber 18 is constructed in a zigzag shape to form a so-called zigzag sifter. The zigzag sifter is essentially vertically oriented. The access area 16 for the sifting chamber 18 is preferably arranged in the upper half of the sifting chamber 18 and on the front wall 19.

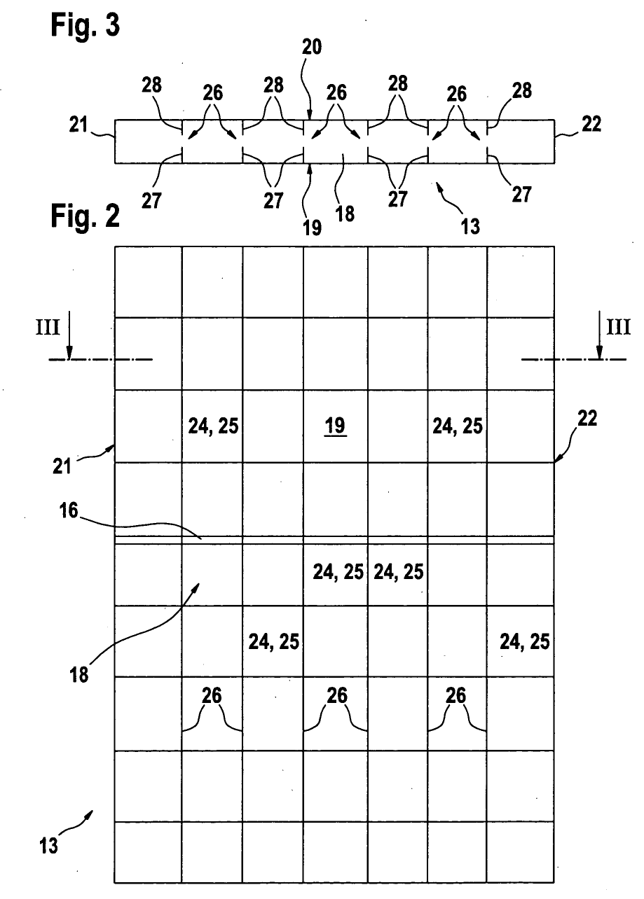

The sifting chamber 18 is divided into at least two, and preferably several sections 24. Each section 24 extends essentially vertically in the direction of the sifting zone 23. According to one non-limiting embodiment shown in FIG. 2, the sections 24 are completely shielded and/or separated from each other. The divided sifting chamber 18 is preferably divided into seven separate compartments 25 which have no access to each other within the sifting arrangement 13. Within each compartment 25, the sifting zone 23 or part of it runs in such a way that seven individual sifting zones 23 extend parallel but separately from each other in the sifting chamber 18. The compartments 25 are formed by partitions 26 which extend from the front wall 19 to the rear wall 20. Preferably each compartment 25 is assigned an access opening 16. The partitions 26 are, like the side walls 21, 22, at least partially of transparent construction so that inspection of the whole sifting chamber 18 from the outside is guaranteed.

The partitions 26 can extend to the input side, that is, in the region of each access 16 at which transfer of the tobacco portions to the sifting arrangement 13 takes place, i.e., they can extend to a transfer area of the steep-angle conveyor 12 or the separating roller 17. In this way, the tobacco portions delivered from the steep-angle conveyor 12 can be guided automatically into one of the compartments 25 via the access openings 16. On the output side, that is, in the region of the junction between the sifting arrangement 13 and the transport zone 14, the partitions 26 extend into the transport zone 14. Although not shown, the invention contemplates that the partitions 26 can also extend within the transport zone 14, in such a way that the sifted product stream, and so in particular the fractions of the product stream suitable for processing, can be guided out of several channels within the transport zone 14. This ensures an even distribution of the product stream across the width into the accumulating shaft 15.

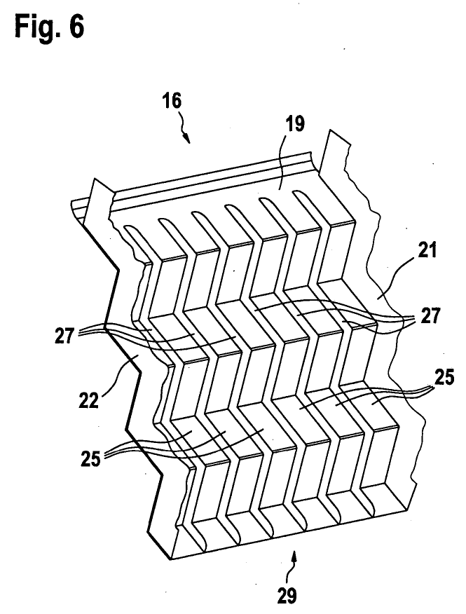

Further, particularly preferred embodiments, which can be of substantially similar and/or identical construction, will now be described with reference to FIGS. 3-6. A detailed description of this embodiment is not provided and the same reference numbers are used for identical parts. The arrangement shown in FIGS. 3-6 is similar to that of FIGS. 1 and 2, except that the partitions 26 are apertured and/or are opened. This means that the compartments 25 are of at least partly open construction, so that adjacent compartments 25 communicate with each other. Instead of the closed partitions 26 used in FIG. 2, this embodiment provides guide elements 27 and 28 which form the partitions 26. The guide elements 27 extend from the front wall 19 and the guide elements 28 extend from the rear wall 20. As can be seen in FIG. 3, these guide elements 27, 28 extend towards each other. The guide plates 27 and 28 of each partition 26 also lie on common planes and are arranged at a distance from each other, so that between the faces of the opposing guide elements 27, 28 of an open partition 26 there is a gap of preferably approximately 30 mm.

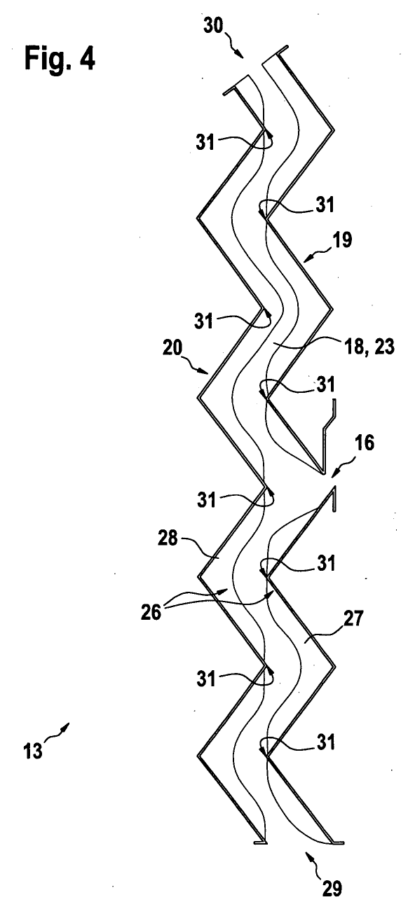

In the embodiment as in FIG. 4, the guide plates 27, 28 extend inwards from the walls 19 and 20, to form the partially open separate compartments 25. These compartments 25 run in a continuous manner in a substantially vertical direction from a lower bottom region 29 and as far as an upper outlet region 30. The inner ends or edges of the guide plates 27, 28 forming the side openings of the compartments 25 also include curved, rounded and/or radiused corner regions 31. The edges also have a zigzag-shape which generally track the shape of the front wall 19 and/or the rear wall 20. In the region of the access area 16 or access areas 16, the guide plates 27, 28 end or terminate in a ramp shape such that the region of each access 16 or the transition to the sifting chamber 18 has essentially no shoulder.

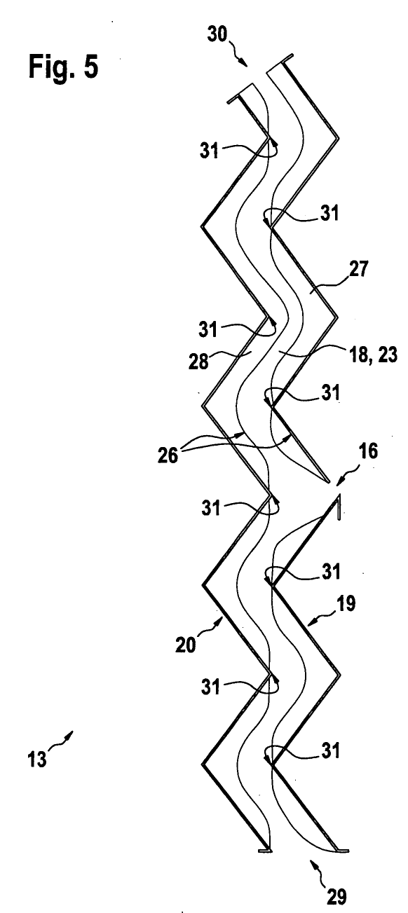

In the embodiment shown in FIG. 5, the guide plates 27, 28 are at least partially interrupted at least in some of the corner regions 31. This means that the guide plates 27, 28 end or terminate before or behind the corresponding corner regions 31 in such a way that these corner regions 31 are free from guide plates 27, 28. The number and arrangement of which corner regions 31 are to be free from guide plates 27, 28 can vary and, like the size, dimensions, and shape of the guide plates 27, 28, can depend critically on the deflection properties of the product stream to be sifted. Also, the flow rates of the air within the sifting zone 23, and the angles of the zigzag-shaped front wall 19 and rear wall 20 can affect the size, shape and design of guide plates 27, 28. By way of non-limiting example, the width of each compartment 25 can be between approximately 140 mm and approximately 160 mm, and is preferably approximately 147 mm. The number of compartments 25 can also vary. Each compartment 25 is preferably freely accessible and/or viewable from the outside. For this purpose the side walls 21, 22 can be releasably attached to the walls 19 and 20 via, e.g., flange plates (not shown) which extend angularly from the front wall 19 and/or rear wall 20.

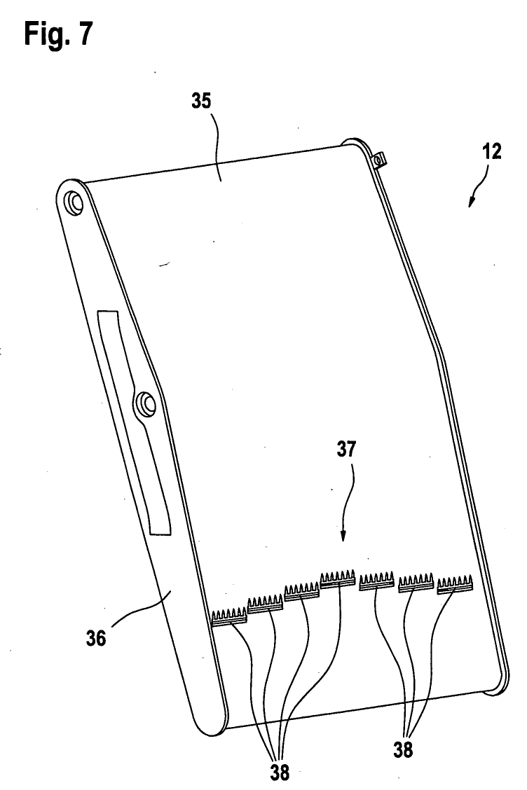

FIG. 7 shows the steep-angle conveyor 12 in detail. The conveyor 12 essentially includes a conveyor belt 35 and a frame system 36 which supports the conveyor belt 35. The conveyor belt 35 has an entraining arrangement and/or a moving system 37 arranged across the whole width of the belt 35. This arrangement 37 are designed as so-called combs 38. Several, preferably seven combs 38 are distributed adjacent to each other across the whole width of the conveyor belt 35. In this way, tobacco or the like can be reliably delivered to the sifting arrangement 13 evenly across the whole width of the conveyor belt 35. The number of combs 38 appropriately corresponds to the number of sections 24 or compartments 25 to be filled. In the direction of transport of the conveyor belt 35, the combs 38 are offset from each other. Due to this offset arrangement, overlapping of tobacco, or the like, in the region of the combs 38 is avoided. This, in turn, makes it easier to feed or introduce the tobacco into the compartments 25.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

1. A sifting arrangement for sifting a product stream, the sifting arrangement comprising:
a zigzag sifter comprising at least one access opening and a sifting chamber that is divided into at least two compartments,
wherein the zigzag sifter is substantially vertically oriented.

2. The sifting arrangement of claim 1, wherein the sifting arrangement is arranged within a distributor apparatus for loading a cigarette-making machine.

3. The sifting arrangement of claim 1, wherein the at least one access opening comprises at least two access openings, each of the at least two access openings allowing entry of the product stream into each of the at least two compartments.

4. The sifting arrangement of claim 1, wherein the at least two compartments are at least partially separated from each other.

5. The sifting arrangement of claim 1, wherein the at least two compartments are separated from each other by a wall.

6. The sifting arrangement of claim 1, wherein the at least two compartments are completely separated from each other.

7. The sifting arrangement of claim 1, wherein the sifting chamber is divided into at least three compartments.

8. The sifting arrangement of claim 1, wherein the zigzag sifter further comprises a lower bottom region and an upper outlet region.

9. The sifting arrangement of claim 1, wherein the zigzag sifter comprises a front wall and a rear wall, and wherein the at least one access opening is arranged in a region of the front wall.

10. The sifting arrangement of claim 1, wherein the at least two compartments are defined by a partition which extends from opposite sides of the sifting arrangement.

11. The sifting arrangement of claim 1, wherein the at least two compartments are defined by a partition which extends from front and rear walls of the zigzag sifter.

12. The sifting arrangement of claim 1, wherein the at least two compartments comprise at least three compartments which are defined by partitions which extend from opposite walls of the zigzag sifter.

13. The sifting arrangement of claim 12, wherein free ends of oppositely arranged partitions are spaced apart from each other so as to define partially open compartments.

14. The sifting arrangement of claim 12, wherein the partitions connect to each of the opposite walls so as to define closed compartments.

15. The sifting arrangement of claim 12, wherein the partitions extend to an outlet region of the zigzag sifter.

16. The sifting arrangement of claim 15, wherein the outlet region is arranged adjacent to a transport zone and downstream of the sifting arrangement, whereby the product stream can be transported from the zigzag sifter via the outlet region to the transport zone.

17. The sifting arrangement of claim 12, wherein the at least one access opening comprises at least three access openings, each of the at least three access openings allowing entry of the product stream into each of the at least three compartments.

18. The sifting arrangement of claim 17, wherein the partitions extend at least to the at least three access openings.

19. The sifting arrangement of claim 1, wherein the at least one access opening is arranged in a region of at least one of a conveyor and a separating roller.

20. The sifting arrangement of claim 1, wherein the sifting chamber is structured and arranged to allow viewing or inspection of its contents from outside.

21. The sifting arrangement of claim 1, wherein the sifting chamber comprises side walls which are at least partially transparent.

22. The sifting arrangement of claim 21, wherein the sifting chamber comprises front and rear walls which are at least partially transparent.

23. The sifting arrangement of claim 1, wherein the sifting chamber comprises a front wall, a rear wall, and oppositely arranged connecting side walls.

24. A zigzag sifting arrangement for sifting a product stream, the sifting arrangement comprising:
a sifting chamber comprising oppositely arranged front and rear walls, oppositely arranged side walls, a plurality of access openings, and a plurality of partition plates extending inwardly from the front and rear walls;
the partition plates being at least one of:
oriented generally parallel to the oppositely arranged side walls; and
oriented generally perpendicular to the front and rear walls,
wherein the partition plates form a plurality of compartments within the sifting chamber, and
wherein each of the plurality of access openings communicates with each of the plurality of at least partially open compartments.

25. The zigzag sifting arrangement of claim 24, wherein the zigzag sifting arrangement is substantially vertically oriented.

26. The zigzag sifting arrangement of claim 24, wherein the plurality of compartments have substantially equal widths.

27. The zigzag sifting arrangement of claim 24, wherein the plurality of compartments have substantially equal sizes.

28. The zigzag sifting arrangement of claim 24, wherein at least one of the partition plates extends continuously from a lower bottom region to an upper outlet region of the sifting chamber.

29. The zigzag sifting arrangement of claim 24, wherein each of the partition plates extends continuously from a lower bottom region to an upper outlet region of the sifting chamber.

30. The zigzag sifting arrangement of claim 24, wherein the plurality of compartments comprise partially open compartments.

31. The zigzag sifting arrangement of claim 24, wherein the plurality of compartments comprise closed compartments.

32. A sifting arrangement for sifting a product stream, the sifting arrangement comprising:
a generally vertically oriented zigzag-shaped sifting chamber comprising oppositely arranged front and rear walls, oppositely arranged side walls, and a plurality of partition plates extending inwardly from the front and rear walls;
at least some of the partition plates being connected to at least the front wall;
at least some of the partition plates being connected to at least the rear wall;
the partition plates being at least one of:
oriented generally parallel to the oppositely arranged side walls; and
oriented generally perpendicular to the front and rear walls,
wherein the partition plates form one of:
a plurality of at least partially open compartments arranged within the zigzag-shaped sifting chamber; and
a plurality of closed compartments arranged within the zigzag-shaped sifting chamber.

33. The sifting arrangement of claim 32, wherein the partition plates comprise curved free ends so as to form the plurality of at least partially open compartments arranged within the zigzag-shaped sifting chamber.

34. The sifting arrangement of claim 32, wherein the partition plates connected to the front wall are arranged opposite from the partition plates connected to the rear wall, whereby open areas are defined between the oppositely arranged partition plates, such that the open areas allow movement of the product stream between adjacent compartments.

35. The sifting arrangement of claim 32, wherein the partition plates extend between corner regions of the front and rear walls and over the corner regions.

36. The sifting arrangement of claim 32, wherein the partition plates extend between adjacent corner regions of the front and rear walls, but not over the corner regions.

37. The sifting arrangement of claim 32, wherein each of the partition plates is connected to each of the front and rear walls so as to form the plurality of closed compartments arranged within the zigzag-shaped sifting chamber.

38. The sifting arrangement of claim 32, further comprising a plurality of access openings arranged in the front wall for supplying product to the zigzag-shaped sifting chamber.
